(19) United States
(12) Patent Application Publication
(10) Pub. No.: US 2017/0337449 A1
(43) Pub. Date: Nov. 23, 2017

(54) PROGRAM, SYSTEM, AND METHOD FOR DETERMINING SIMILARITY OF OBJECTS

(71) Applicant: DeNA Co., Ltd., Tokyo (JP)

(72) Inventors: Koichi HAMADA, Tokyo (JP); Kazuki FUJIKAWA, Tokyo (JP)

(73) Assignee: DeNA Co., Ltd.

(21) Appl. No.: 15/599,847

(22) Filed: May 19, 2017

(30) Foreign Application Priority Data
May 19, 2016 (JP) 2016-100332

(51) Int. Cl. G06K 9/62; G06N 3/04; G06N 3/08; G06F 17/30

(52) U.S. Cl. CPC G06K 9/6215; G06N 3/08; G06N 3/04; G06K 9/6202; G06F 17/3028

(57) ABSTRACT

A method for determining the similarity of objects pertaining to an embodiment uses a convolutional neural network (CNN) that includes one or more convolutional layers and a fully-connected layer to cause one or more computers to execute the following steps in response to said method being executed on said one or more computers: extracting a plurality of characteristic amounts from each of a plurality of objects; extracting output values of the fully-connected layer following the one or more convolutional layers of the convolutional neural network (CNN) on the basis of said plurality of characteristic amounts from each of said plurality of objects; performing conversion processing in which output values of the fully-connected layer serve as a range within a specific area, and extracting conversion output values; and distinguishing the similarity of objects on the basis of said conversion output values.

This application claims foreign priority under 35 USC 119 based on Japanese Patent Application No. 2016-100332, filed on May 19, 2016, the contents of which is incorporated herein in its entirety by reference.

### BACKGROUND

### 1. Field

The present invention relates to a program (e.g., non-transitory computer-readable medium having a storage including instructions to be performed by a processor), a system, and a method for determining the similarity of objects, and more precisely relates to a program, a system, and a method for determining the similarity of objects using a convolutional neural network (CNN).

### 2. Related Art

A neural network is a model that simulates the neurons and synapses of the brain, and is constituted by two stages of processing: learning and identification. In the learning stage, characteristics are learned from numerous inputs, and a neural network for identification processing is constructed. In the identification stage, the neural network is used to identify whether new inputs are possible. In recent years, technology related to the learning stage has made significant advances. For instance, it is becoming possible to construct a multilayer neural network having high reproducibility by means of deep learning. In particular, the efficacy of a multilayer neural network has been confirmed in tests of voice recognition or image recognition, and the efficacy of deep learning is now widely recognized.

The use of a convolutional neural network (CNN) is a known method for constructing such a multilayer neural network and performing image identification (see Non-Patent Document 1, for example). The multilayer neural network featuring a convolutional neural network (CNN) discussed in Non-Patent Document 1 is called AlexNet, and is characterized by the fact that LeNet5 is expanded to multiple layers, and that a rectified linear unit (ReLU) or the like is used as the output function for each unit.

### PRIOR ART DOCUMENT

### Non-Patent Document

Non-Patent Document 1: “ImageNet Classification with Deep Convolutional Neural Networks,” Alex Krizhevsky, Ilya Suskever, Geoffrey E. Hinton

### SUMMARY

### Problems to be Solved by the Invention

With the conventional image identification method mentioned above, it is understood that the error rate in specifying objects included in images can be reduced more than in the past. However, with this method, a problem was that accurate and efficient extraction was impossible when a search focused on a particular element within an object that included numerous elements.

It is an object of the embodiments of the present invention to properly determine the similarity between elements included in an object. Other objects of the embodiments of the present invention will become more clear by referring to this Specification as a whole.

### Means for Solving the Problems

The method pertaining to an embodiment of this invention is a similar image determination method that determines the similarity between a plurality of objects using a convolutional neural network (CNN) that includes one or more convolutional layers and a fully-connected layer, said method being configured to cause one or more computers to execute the following steps in response to said method being executed on said one or more computers: extracting a plurality of characteristic amounts from each of a plurality of objects; extracting output values of the fully-connected layer following the one or more convolutional layers of said convolutional neural network (CNN) on the basis of said plurality of characteristic amounts from each of said plurality of objects; performing conversion processing in which output values of the fully-connected layer serve as a range within a specific area, and extracting conversion output values; and distinguishing the similarity of objects on the basis of said conversion output values.

The system pertaining to an embodiment of this invention is a similar image determination system that determines the similarity between a plurality of objects using a convolutional neural network (CNN) that includes one or more convolutional layers and a fully-connected layer, said system being configured to cause one or more computers to execute the following steps in response to said system being executed on said one or more computers: extracting a plurality of characteristic amounts from each of a plurality of objects; extracting output values of the fully-connected layer following the one or more convolutional layers of the convolutional neural network (CNN) on the basis of said plurality of characteristic amounts from each of said plurality of objects; performing conversion processing in which output values of the fully-connected layer serve as a range within a specific area, and extracting conversion output values; and distinguishing the similarity of objects on the basis of said conversion output values.

The program (e.g., non-transitory computer-readable medium having a storage including instructions to be performed by a processor) pertaining to the above-mentioned embodiment is a program that determines the similarity between a plurality of objects using a convolutional neural network (CNN) that includes one or more convolutional layers and a fully-connected layer, said program being configured to cause one or more computers to execute the following steps in response to said program being executed on said one or more computers: extracting a plurality of characteristic amounts from each of a plurality of objects; extracting output values of the fully-connected layer following the one or more convolutional layers of the convolutional neural network (CNN) on the basis of said plurality of characteristic amounts from each of said plurality of objects; performing conversion processing in which output values of the fully-connected layer serve as a range within a specific area, and extracting conversion output values; and distinguishing the similarity of objects on the basis of said conversion output values.

### Effects of the Invention

The various embodiments of the present invention make it possible for the similarity between elements included in objects to be properly determined by making use of a multilayer neural network that features a convolutional neural network (CNN).

### BRIEF DESCRIPTION OF THE DRAWINGS

FIG. 1A simplified diagram of the configuration of a system 1 pertaining to an embodiment of the present invention.

FIG. 2A simplified block diagram of the functions of the system 1 in an embodiment.

FIG. 3A diagram showing an example of similar image determination flow in an embodiment.

FIG. 4A diagram showing an example of the flow of category classification of objects in each image using an existing convolutional network in an embodiment.

FIG. 5A flowchart showing an example of a sigmoid function in an embodiment.

FIG. 6A simplified diagram of similarity evaluation by means of distance scale comparison in an embodiment.

### DETAILED DESCRIPTION

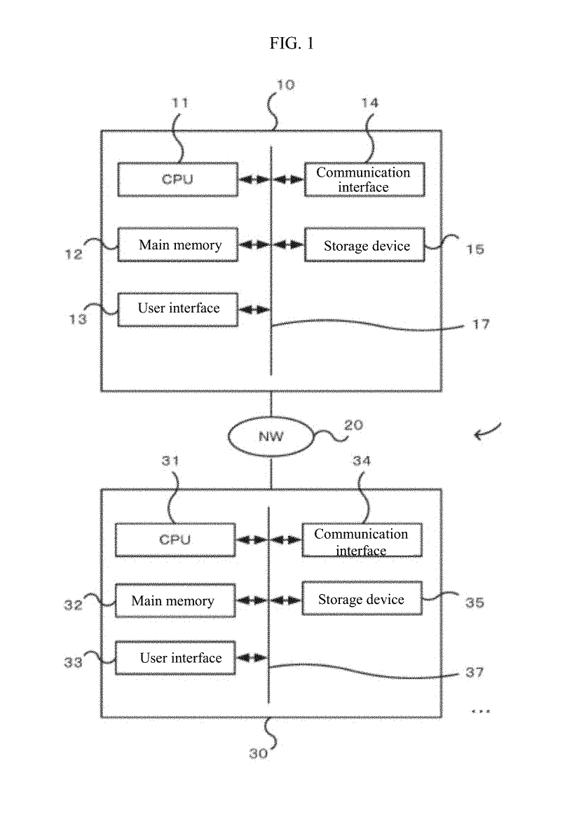

FIG. 1 is a simplified diagram of the configuration of the system 1 pertaining to an embodiment of the present invention. As shown in the drawings, the system 1 in an embodiment comprises a server 10 and a plurality of terminal devices 30 that are connected to this server 10 via the Internet or another such communications network 20, and provides an e-commerce service to the users of the terminal devices 30. Also, the system 1 in an embodiment can provide the users of the terminal devices 30 with character-based games, as well as digital books, video content, music content, and various other digital content other than games, plus communication platform (SNS platform) services that allow for communication between various users, such as text chatting (private messaging), clubs, avatars, blogs, message boards, greetings, and various other Internet services.

The server 10 in an embodiment is configured as a typical computer, and as shown in the drawings, includes a CPU (computer processor) 11, a main memory 12, a user interface 13, a communication interface 14, and a storage (memory) device 15. These constituent components are electrically connected together via a bus 17. The CPU 11 loads an operating system or various other programs (e.g., non-transitory computer-readable medium or media having a storage including instructions to be performed by a processor) from the storage device 15 to the main memory 12, and executes the commands included in the loaded program. The main memory 12 is used to store programs executed by the CPU 11, and is made up of a DRAM or the like, for example. The server 10 in an embodiment can be configured using a plurality of computers each having a hardware configuration such as that discussed above. The above-mentioned CPU (computer processor) 11 is just an example, and it should go without saying that a GPU (graphics processing unit) may be used instead. How to select the CPU and/or GPU can be suitably determined after taking into account the desired cost, efficiency, and so forth. The CPU 11 will be used as an example in the following description.

The user interface 13 includes, for example, an information input device such as a keyboard or a mouse that receives operator input, and an information output device such as a liquid crystal display that outputs the computation results of the CPU 11. The communication interface 14 is configured as hardware, firmware, communication software such as a TCP/IP driver or a PPP driver, or a combination of these, and is configured to be able to communicate with the terminal devices 30 via the communications network 20.

The storage device 15 is constituted by a magnetic disk drive, for example, and stores various programs such as control programs for providing various services. Various kinds of data for providing various services can also be stored in the storage device 15. The various kinds of data that can be stored in the storage device 15 may also be stored in a database server or the like that is physically separate from the server 10 and that is connected so as to be able to communicate with the server 10.

In an embodiment, the server 10 also functions as a web server that manages a web site consisting of a plurality of web pages with a hierarchical structure, and can provide various services through this web site to the users to the terminal devices 30. HTML data corresponding to these web pages can also be stored in the storage device 15. The HTML data has a variety of image data associated with it, or various programs written in a script language such as Java Script (registered trademark) or the like can be embedded.

Also, in an embodiment, the server 10 can provide various services via applications (programs, or non-transitory computer-readable medium having a storage including instructions to be performed by a processor) executed in an execution environment other than a web browser at the terminal devices 30. These applications can also be stored in the storage device 15. These applications are produced, for example, using Objective-C, Java (registered trademark), or another such programming language. The applications stored in the storage device 15 are distributed to the terminal devices 30 in response to a distribution request. The terminal devices 30 can also download these applications from a server other than the server 10 (a server that provides an application marketplace) or the like.

Thus, the server 10 can manage web sites for providing various services, and distribute the web pages (HTML data) constituting said web sites in response to requests from the terminal devices 30. Also, as discussed above, the server 10 can provide various services on the basis of communication with applications executed at the terminal devices 30, either alternately or in addition to the provision of various services using these web pages (web browser). No matter how said services are provided, the server 10 can send and receive various data required for the provision of various services (including the data required for image display) to and from the terminal devices 30. Also, the server 10 stores various kinds of data for each set of identification information used to identify each user (such as a user ID), and can manage the provision status of the various services for each user. Although not described in detail, the server 10 may also have a function of performing user verification processing, billing processing, and so forth.

A terminal device 30 in an embodiment is a type of information processing device that, along with displaying the web pages of web sites provided by the server 10 on a web browser, provides an execution environment for executing applications and can include a smart phone, a tablet terminal, a wearable device, a personal computer, a dedicated game terminal, and the like, but is not limited to these.

The terminal device 30 is configured as a typical computer, and as shown in FIG. 1, includes a CPU (computer processor) 31, a main memory 32, a user interface 33, a communication interface 34, and a storage (memory) device 35. These constituent components are electrically connected together via a bus 37.

The CPU 31 loads an operating system or another program from the storage device 35 to the main memory 32, and executes the commands included in the loaded program (e.g., non-transitory computer-readable medium having a storage including instructions to be performed by a processor). The main memory 32 is used to store programs executed by the CPU 31, and is made up of a DRAM or the like, for example.

The user interface 33 includes, for example, an information input device such as a touch panel, a keyboard, buttons, or a mouse that receives operator input, and an information display device such as a liquid crystal display that outputs the computation results of the CPU 31. The communication interface 34 is configured as hardware, firmware, communication software such as a TCP/IP driver or a PPP driver, or a combination of these, and is configured to be able to communicate with the server 10 via the communications network 20.

The storage device 35 is constituted by a magnetic disk drive or a flash memory, for example, and stores various programs such as an operating system. Various applications received from the server 10 can also be stored in the storage device 35.

The terminal device 30 comprises a web browser for interpreting HTML files (HTML data) and displaying it on as screen, for example. This web browser function allows the HTML data acquired from the server 10 to be interpreted and a web page corresponding to the received HTML data to be displayed. Also, plug-in software capable of executing files of various formats associated with HTML data can be incorporated into the web browsers of the terminal device 30.

When the user of a terminal device 30 makes use of a service provided by the server 10, an animation, an operational icon, or the like indicated by an application or HTML data is displayed on the screen of the terminal device 30, for example. The user can use the touch panel or the like of the terminal device 30 to input various commands. A command inputted by the user is transmitted to the server 10 through the function of an application execution environment, such as NgCore (trademark) or the web browser of the terminal device 30.

Next, the functions of the system 1 in an embodiment configured as above will be described. As discussed above, the system 1 in an embodiment can provide various Internet services to users, and in particular it is able to provide e-commerce services or content distribution services. The functions of the system 1 in an embodiment will be described below, using the function of providing an e-commerce service as an example.

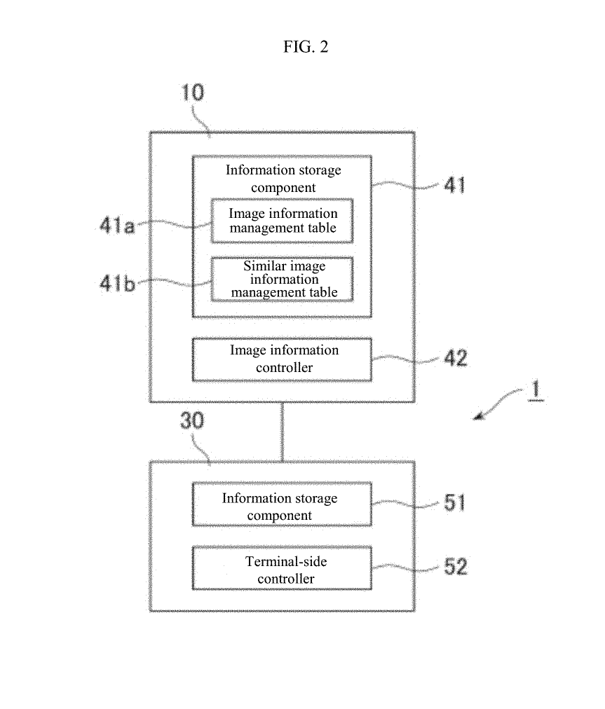

FIG. 2 is a simplified block diagram of the functions of the system 1 (the server 10 and the terminal device 30). First, we will describe the functions of the server 10 in an embodiment. As shown in the drawings, the server 10 comprises an information storage component 41 that stores various kinds of information, and an image information controller 42 for providing a specific image to a user in an embodiment and selecting and providing images that are similar to the first one. Images are used as the example in the description of this embodiment, but the object of evaluation for similarity is not limited to this, and can include text or audio or other signals, for example. In this Specification, all of these shall be defined as the object. Therefore, the above-mentioned image information controller 42 could also be called the object information controller 42. For the sake of this description, an image will be described herein as an example of an object of similarity determination. These functions can be realized by the joint operation of various kinds of programs, tables, etc., stored in the storage device 15, as well as hardware such as the CPU 11 and the main memory 12. For instance, these can be realized by having the CPU 11 execute commands included in a program (e.g., non-transitory computer-readable medium having a storage including instructions to be performed by a processor) that has been loaded. Also, some or all of the functions of the server 10 in the example shown in FIG. 2 may be realized by the terminal device 30, or may be realized by joint operation by the server 10 and the terminal device 30.

The information storage component 41 in an embodiment is constituted by the storage device 15, etc., and as shown in FIG. 2, has an image information management table 41a that manages image information about merchandise provided in an e-commerce service, and a similar image information management table 41b that manages image information related to images of merchandise similar to the first merchandise.

Next, we will describe the functions of the image information controller 42 for providing a specific image to a user in an embodiment and selecting and providing images that are similar to the first one. The image information controller 42 uses a neural network with a multilayer structure built by machine learning to express images as multi-dimensional vectors, and ultimately determines similar images by approximating vectors or comparing the distance between these vectors. The similar images that are thus extracted are put into the above-mentioned similar image information management table 41b.

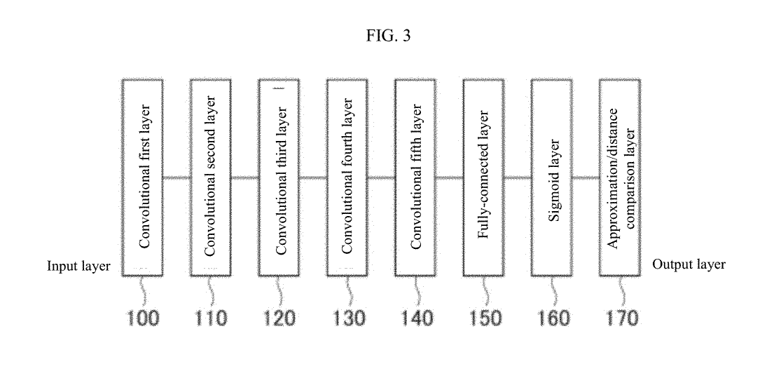

More specifically, FIG. 3 shows a similar image determination method that is one of the functions of the image information controller 42. The similar image determination method in an embodiment first extracts a characteristic amount from the image that is the object (input layer). After this, the method goes through five convolutional layers 100 to 140, and then a fully-connected layer 150 as the sixth layer.

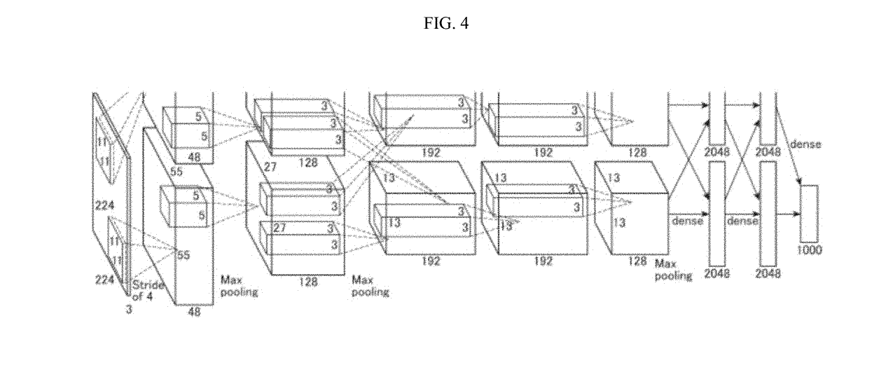

The above-mentioned first to fifth convolutional layers and the fully-connected layer (sixth layer) will now be described through reference to FIG. 4. FIG. 4 shows the architecture of the convolutional network of AlexNet (FIG. 4 corresponds to FIG. 2 disclosed in Non-Patent Document 1). As shown in the drawing, the convolutional network of AlexNet is made up of five convolutional layers and three fully-connected layers. The output of the last fully-connected layer is fed to a 1000-way softmax which produces a distribution over the 1000 class labels. As shown in FIG. 4, the kernels of the second, fourth, and fifth convolutional layers are connected only to those kernels in the previous layer which reside on the same GPU. The kernels of the third convolutional layer are connected to all kernels in the second layer.

The neurons in the fully-connected layers are connected to all neurons in the previous layer. A configuration is employed in which response-normalization layers follow the first and second convolutional layers. Also, a configuration is employed in which max-pooling layers follow the response-normalization layers and the fifth convolutional layer. ReLU (rectified linear units) are applied to the output of every convolutional and fully-connected layer.

The first convolutional layer filters the 224×224×3 input image with 96 kernels that are 11×11×3 in size (with a stride of 4 pixels). The second convolutional layer takes as input the (response-normalized and pooled) output of the first convolutional layer and filters it with 256 kernels that are 5×5×48 in size. The third, fourth, and fifth convolutional layers are connected to one another without any intervening pooling or response-normalization layers. The third convolutional layer has 384 kernels that are 3×3×256 in size and are connected to the (response-normalized and pooled) outputs of the second convolutional layer. The fourth convolutional layer has 384 kernels that are 3×3×192 in size, and the fifth convolutional layer has 256 kernels that are 3×3×192 in size. The fully-connected layers have 4096 neurons each.

One feature of the invention pertaining to an embodiment is the use of the existing architecture of the convolutional network of AlexNet shown in FIG. 4. However, it has come to be understood that if the final output values of this convolutional network are used just as they are, the characteristic amounts for the category classification of objects in each image will end up being extracted too large, making it difficult to distinguish the similarity between images that include an object in a mode that is not dependent on the category of the object. In view of this, with the invention in this embodiment, repeated experimentation led to the discovery that the similarity between images that include an object in a mode that is not dependent on the category of the object can be effectively distinguished by going ahead and making use of the output values of a sixth fully-connected layer following the first to fifth convolutional layers of AlexNet, that is, output values in a state in which characteristic amounts that are more suited to the category classification of an object have relatively little effect while other characteristic amounts of an object have relatively high effect.

The existing architecture of the convolutional network of AlexNet was used with the invention pertaining to an embodiment, but this is not intended to limit the number of convolutional layers or fully-connected layers, and it should go without saying that suitable modifications are possible while taking into account cost and improved efficiency.

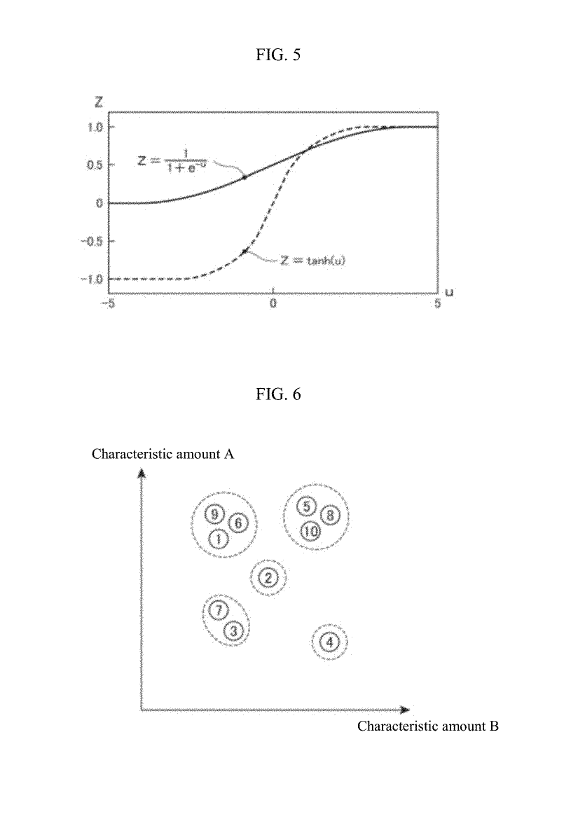

As discussed above, the invention pertaining to an embodiment makes use of the output values of the fully-connected layer (sixth layer) following a convolutional first layer 100, a convolutional second layer 110, a convolutional third layer 120, a convolutional fourth layer 130, and a convolutional fifth layer 140. Nevertheless, since the output values of this sixth layer have a threshold from −∞ to ∞, to put that threshold within a specific range, a sigmoid function can be used to put the output values within a range of from 0 to 1. A sigmoid layer 160 (seventh layer) can have output values between 0 and 1 by applying the sigmoid function indicated by the solid line in FIG. 5. Meanwhile, if the sigmoid function indicated by the dotted line in FIG. 5 is applied, the output values will be from −1 to 1.

Setting the output value to be between 0 and 1 by going through a sigmoid layer at this stage allows the subsequent approximation or comparison of distance scale to be carried out easily and efficiently. Also, while thus limiting the output value does somewhat lower the accuracy in determining the category classification of objects included in images, the similar image determination in this embodiment is aimed not only at extracting what is similar to an image that includes an object of the same category, but also at extracting images that include objects having similar characteristics even though the objects may be from different categories, so it has become clear from various experiments that this is a highly accurate and efficient method for extracting similar images.

After going through the sigmoid layer 160, then, the similarity between a plurality of images is determined at an approximation/distance comparison layer 170, based on a conversion output value in which the output value ranges from 0 to 1. Methods for evaluating similarity between a plurality of images include an approximate nearest neighbor search method in which hashing or a step function is used. More specifically, Locality-Sensitive Hashing (LSH) be used as an approximate nearest neighbor search method in which hashing is used. LSH involves the use of a hashing function with which there is a higher probability of obtaining a closer hash value the greater is the local sensitivity, that is, the shorter is the distance, which allows an approximate nearest point in a vector space to be extracted, the data space is linearly divided up to extract points that fall within the same region as the query, and distance calculation is performed. A hash function such as this refers to a hash function characterized by the fact that short-distance inputs collide at a high probability. A hash table can be produced in which short-distance data are mapped to the same value at a high probability, and the configuration can be such that a plurality of hash functions are used to greatly lower the collision probability when the distance is at or over a certain level. Consequently, the similarity between a plurality of images is evaluated, and it is determined whether or not the images have similarity.

Meanwhile, another method for evaluating the similarity between a plurality of images with the approximation/distance comparison layer 170 is a method that involves finding the distance between points corresponding to various images within a characteristic amount space, and the Euclid distance, the Hamming distance, the cosign distance, or the like is used for this purpose. This method is characterized by comparing the distance scale, which indicates that a plurality of images in nearby positions within a characteristic amount space are similar to each other. With this method, it is possible to estimate the degree of similarity between a plurality of images by calculating the distance between the images in a characteristic amount space. A two-dimensional characteristic amount space featuring two types of characteristic amount A and B will be described as an example, but the following concept can be expanded and applied to characteristic amount spaces of higher dimensions. As an example, let us consider a case in which 10 images (P=10) are plotted, according to the values of their characteristic amounts, in a two-dimensional characteristic amount space in which the coordinate axes are the characteristic amounts X1 and X2. In FIG. 6, the circled numbers indicate the positions of images within a characteristic amount space, and the numbers represent the respective image numbers.

In the example in FIG. 6, images 1, 6, and 9 were determined to be similar, and images 5, 8, and 10 were also determined to be similar. Also, images 3 and 7 are similar, but it was determined that there were no images similar to images 2 and 4.

Thus, images that are similar to a particular image are ultimately determined via an approximation/distance comparison layer. At the learning stage, the characteristics thereof are learned from numerous input data produced by sensors, and a convolutional network is constructed. The convolutional network thus constructed is expressed as a weight coefficient used by the computational components of the image information controller 42. For example, when input data corresponding to an image in which a certain numeral “x” was plotted has been inputted, a weight coefficient is found such that the output will be that the input data is “x.” Receiving a large quantity of input data increases the accuracy of a neural network. In this embodiment, the image information controller 42 shall be assumed to construct a convolutional network by some known means.

The functions of the server 10 were described above. Next, we will describe the functions of the terminal device 30 in an embodiment. As shown in FIG. 2, the terminal device 30 has an information storage component 51 that stores a variety of information, and a terminal-side controller 52 that executes control for displaying image information on the terminal side in an embodiment. These functions can be realized by the joint operation of hardware such as the CPU 31 or the main memory 32, and various programs, tables, etc., stored in the storage device 35. For example, they can be realized by having the CPU 31 execute the commands included in a program (e.g., non-transitory computer-readable medium having a storage including instructions to be performed by a processor) that has been loaded. Also, some or all of the functions of the terminal device 30 in the example shown in FIG. 2 can be realized by the server 10, or can be realized by joint operation by the server 10 and the terminal device 30.

The information storage component 51 in this embodiment is realized by the main memory 32, the storage device 35, or the like. The terminal-side controller 52 in this embodiment controls the execution of various kinds of processing on the terminal side, such as a transmission request for image information or the display of received image information. For instance, if the user wants to purchase merchandise such as clothing or eyeglasses, the terminal-side controller 52 searches for images that would be candidates for those, and the results are received from the server 10 and displayed, or the images received from the server 10 can be displayed along with similar images.

The result of the above is that in a service such as e-commerce or the distribution of digital content, if there are images similar to images of the object being sold or images included in the content to be distributed, then the server 10 can send them as image information to be displayed on the terminal 30 of the user. As a result, the user can efficiently find and purchase the merchandise to be purchased along with similar merchandise, or the content the user wishes to distribute can be introduced along with content that includes similar images, which allows the user to more easily ascertain image information that matches his own preferences, and in some cases the purchase or distribution of this image information can also be performed. As discussed above, images were described as the example in this embodiment, but this is not the only option, and the present inventive concept may be broadly applied to objects that include text or audio or other signals, for example.

As another example of determining the similarity of objects, the present invention may also be applied to determining the similarity of dialog text. In an embodiment, let us assume that a user who is close to the persona image (a woman in her thirties will be used as an example) says, “I (first person singular feminine) like Keisuke Honda.” Let us assume that there are other users A and B, and that A says “I (first person singular masculine) like Keisuke Honda,” while B says “I (first person singular feminine) like Shinji Kagawa.” In this case, in an evaluation of the similarity of the dialog text, conventional natural language processing would generally conclude that the statement of A that matches “Keisuke Honda,” which is a low-frequency term, is close to the original statement. However, it has been confirmed that by repeatedly learning in advance, when searching not only for the “details of the statement,” but also for the statement of another user that is close to “the statement of the user of a targeted persona image,” the embodiment can be applied to the task of extracting the statements of other users who have made statements close in taste and character to the statement details of the user of the targeted persona image in a dialog example search by making use of the above-mentioned multilayer neural network. In a dialog example search such as this, not only low-frequency terms, but also words with a relatively high frequency such as “I (first person singular masculine)” and “I (first person singular feminine)” are effective for such classification, and configuring a distance space in which the difference between such words is given importance becomes effective at determining similarity for the purpose of searching not only for the above-mentioned images, but also for other objects such as “statements close in taste and character.”

The processing and procedures described in this Specification are realized by software, hardware, or a combination of these, in addition to what was clearly described in the embodiments. More specifically, the processing and procedures described in this Specification are realized by loading logic corresponding to said processing onto a medium such as an integrated circuit, a volatile memory, a non-volatile memory, a magnetic disk, or optical storage. Also, the processing and procedures described in this Specification may be such that they are loaded as computer programs (e.g., non-transitory computer-readable medium having a storage including instructions to be performed by a processor) that are executed by various kinds of computers.

Even though the processing and procedures described in this Specification were described as being executed by a single device, software, a component, or a module, the processing and procedures may be executed by a plurality of devices, a plurality of sets of software, a plurality of components, and/or a plurality of modules. Also, even though the description in this Specification indicated that data, a table, or a database was stored in a single memory, the data, table, or database may instead be divided up and stored in a plurality of memories provided to a single device or in a plurality of memories that are divided up and disposed in a plurality of devices. Furthermore, the software and hardware elements described in this Specification may be realized by consolidating them into fewer constituent elements, or by breaking them up into more constituent elements.

In this Specification, whether the constituent elements of the invention were described as being singular or plural, or whether they were described without being limited to either singular or plural, these constituent elements may be either singular or plural, except when the context makes it clear that they should be understood otherwise.

### DESCRIPTION OF THE REFERENCE NUMERALS

10 server
20 communications network
30 terminal device
41 information storage component
42 image information controller
51 information storage component
52 terminal-side controller
100 convolutional first layer
110 convolutional second layer
120 convolutional third layer
130 convolutional fourth layer
140 convolutional fifth layer
150 fully-connected layer
160 sigmoid layer
170 approximation/distance comparison layer

1. A similarity determination method for determining the similarity between a plurality of objects using a convolutional neural network (CNN) that includes one or more convolutional layers and a fully-connected layer, said method causing one or more computers to execute the following operations in response to said method being executed on said one or more computers:
extracting a plurality of characteristic amounts from each of a plurality of objects;
extracting output values of the fully-connected layer following the one or more convolutional layers of the convolutional neural network (CNN) based on said plurality of characteristic amounts from each of said plurality of objects;
performing conversion processing in which output values of the fully-connected layer serve as a range within a specific area, and extracting conversion output values; and
distinguishing the similarity based on said conversion output values.

2. The method according to claim 1, wherein the convolutional neural network (CNN) comprises a plurality of convolutional layers, and output values of the following fully-connected layer serve as said output values.

3. The method according to claim 1,
wherein the convolutional neural network (CNN) comprises five convolutional layers, and output values of the following fully-connected layer serve as said output values.

4. The method according to claim 1,
wherein the convolutional neural network (CNN) comprises five convolutional layers and one fully-connected layer, and output values of said fully-connected layer serve as said output values.

5. The method according to claim 1,
wherein said conversion processing in which output values of the fully-connected layer serve as a range within a specific area is performed using a sigmoid function.

6. The method according to claim 1,
wherein said conversion processing in which output values of the fully-connected layer serve as a range within a specific area is performed using a sigmoid function so that the range of the output values will be from 0 to 1.

7. The method according to claim 1,
wherein the distinguishing similar images based on said conversion output values is performed by approximating each of the output values after the conversion processing, and comparing the approximated values.

8. The method according to claim 1,
wherein the distinguishing similar images based on said conversion output values is performed by approximating each of the output values after the conversion processing by LSH, and comparing the approximated values.

9. The method according to claim 1,
wherein the distinguishing similar images based on said conversion output values is performed by finding a distance scale involving the Euclidean distance, the cosign distance, and the Hamming distance for each of the output values after the conversion processing, and comparing said distance scales.

10. A method for presenting a merchandise image to a user via a network, wherein images of similar merchandise extracted using the method of claim 1 are presented to the user along with the merchandise images that the user has searched for.

11. A method for distributing content to a user via a network, wherein similar content extracted using the method of claim 1 is presented to the user along with the distribution of the content that the user is viewing.

12. A similarity determination system for determining the similarity between a plurality of objects using a convolutional neural network (CNN) that includes one or more convolutional layers and a fully-connected layer, said system causing one or more computers to execute the following operations, in response to said system being executed on said one or more computers:
extracting a plurality of characteristic amounts from each of a plurality of objects;
extracting output values of the fully-connected layer following the one or more convolutional layers of the convolutional neural network (CNN) based on said plurality of characteristic amounts from each of said plurality of objects;
performing conversion processing in which output values of the fully-connected layer serve as a range within a specific area, and extracting conversion output values; and
distinguishing the similarity of objects based on said conversion output values.

13. A non-transitory computer-readable medium having a storage including instructions to be performed by a processor, for determining the similarity between a plurality of objects using a convolutional neural network (CNN) that includes one or more convolutional layers and a fully-connected layer, said instructions comprising:
extracting a plurality of characteristic amounts from each of a plurality of objects;
extracting output values of the fully-connected layer following the one or more convolutional layers of the convolutional neural network (CNN) based on said plurality of characteristic amounts from each of said plurality of objects;
performing conversion processing in which output values of the fully-connected layer serve as a range within a specific area, and extracting conversion output values; and
distinguishing the similarity of objects based on said conversion output values.
